(19) United States
(12) Patent Application Publication
(10) Pub. No.: US 2022/0008845 A1
(43) Pub. Date: Jan. 13, 2022

(54) WASHING MACHINE WITH FILTER GROUP

(71) Applicant: UFI INNOVATION CENTER S.R.L., Ala, Trento (IT)

(72) Inventor: Giorgio GIRONDI, Ala, Trento (IT)

(21) Appl. No.: 17/289,562

(22) PCT Filed: Oct. 21, 2019
(86) PCT No.: PCT/IB2019/058948

§ 371 Date: Apr. 28, 2021

(30) Foreign Application Priority Data
Oct. 31, 2018 (IT) 102018000009963

(51) Int. Cl. B01D 29/23; B01D 39/16; B01D 29/56; B01D 29/92; B01D 29/60; B01D 35/143; C02F 1/00; D06F 39/08; D06F 39/10; D06F 33/42

(52) U.S. Cl. CPC B01D 29/23; C02F 2103/002; B01D 29/56; B01D 29/925; B01D 29/606; B01D 35/143; C02F 1/001; D06F 39/085; D06F 39/10; D06F 33/42; B01D 2239/0216; B01D 2239/1233; B01D 2239/0618; B01D 2239/1258; B01D 2239/0492; B01D 39/1623

(57) ABSTRACT

A washing machine (900) includes a drum (910) in which washing operations are carried out, a drainage hose (950) fluidically connected to the drum (910) and fluidically connectable to a drainage system and a filter group (1) positioned along the drainage hose (950). The filter group (1) filters synthetic microfibers of micrometric size and is made of a non-woven fabric having synthetic fibers.

The present invention relates to a washing machine. Moreover, the present invention relates to a filter group for a washing machine. In addition, the present invention relates to a filtration system, which comprises a filter group, for a washing machine.

In particular, the present invention relates to the field of domestic and/or industrial washing of fabrics and consequently to fabric products, such as a garment. More specifically, the present invention focuses its attention on the washing of synthetic fabrics, i.e. fabrics that in their entirety, or in a portion thereof, are made of polyester, polypropylene, polyamide and/or acrylic.

### STATE OF THE ART

In the state of the art a plurality of washing machine solutions are known in which the functioning of the washing operations is well known.

It has been ascertained that in the known washing machines, during the operations of washing the fabrics, these fabrics produce micrometric-sized fibers that drain into the drainage systems and thus into the environment, polluting it. In particular, the production of microfibers is mostly due to the washing method, to the action of the centrifuge (and in particular to the ever higher centrifugation speeds), the type of detergent, the hardness of the water, etc.

In recent years there has been an increase in the diffusion of synthetic fabrics. As a result, there has also been an increase in the diffusion of the quantity of micrometric synthetic microfibers in waste water and thus in the environment, resulting in greater environmental pollution. In particular, synthetic microfibers are produced/released in the washing of synthetic fabrics which are non-biodegradable and therefore cause greater water pollution by microplastics (the term refers to particles/fibers with a length of less than 5 mm or even 1 mm).

In particular, an increase in the water of synthetic particles/microfibers of micrometric dimensions, i.e. with a length of less than 5 mm, has been observed.

### SOLUTION OF THE INVENTION

In view of the above, the need to resolve this problem is strongly felt, avoiding the polluting release of synthetic microfibers into the environment. In other words, the need is strongly felt to prevent the possibility that washing machines drain off synthetic microfibers produced during the washing phases of synthetic fabrics. In yet other words, the need is strongly felt to prevent the increase in the amount of microfibers found in waste water minimizing microplastic water pollution.

The object of the present invention is, therefore, to provide a new washing machine and/or a filter group and/or filtration system that meet such need.

Such object is achieved by a washing machine according to that which is claimed in claim 1. Similarly, such object is achieved by a filter group as claimed in claim 18. In addition, such object is achieved by a filtration system as claimed in claim 19. The claims dependent on these show preferred embodiments involving further advantageous aspects.

### DESCRIPTION OF THE DRAWINGS

Further characteristics and advantages of the invention will be evident from the description given below of its preferred embodiments, made by way of a non-limiting example with reference to the appended drawings, wherein:

FIG. 1 shows a schematic view of a washing machine according to the present invention;

FIG. 2 illustrates a perspective view of a filtration system comprising a filter body containing a filter group, according to a preferred embodiment of the present invention;

FIG. 3 represents a perspective view, in partial cross-section, of the filtration system referred to in FIG. 2, according to a first embodiment;

FIG. 3′ shows a front view of the filtration system in FIG. 3;

FIGS. 3a and 3b represent two longitudinal cross-section views in a filtration configuration of the filtration system, respectively along the section plane A-A and B-B shown in FIG. 3′;

FIGS. 3a′ and 3b′ show two longitudinal cross-section views in a bypass configuration of the filtration system, respectively along the section planes A-A and B-B shown in FIG. 3′;

FIG. 4 represents a perspective view, in partial section, of the filtration system referred to in FIG. 2, according to a second embodiment;

FIG. 4′ illustrates a front view of the filtration system in FIG. 4;

FIGS. 4a and 4b represent two longitudinal cross-section views in a filtration configuration of the filtration system, respectively along the section plane C-C and D-D shown in FIG. 4′;

FIGS. 4a′ and 4b′ show two longitudinal cross-section views in a bypass configuration of the filtration system, respectively along the section planes C-C and D-D shown in FIG. 4′;

FIG. 5 illustrates a block diagram representative of an operating scheme of the washing machine of the present invention according to a preferred embodiment.

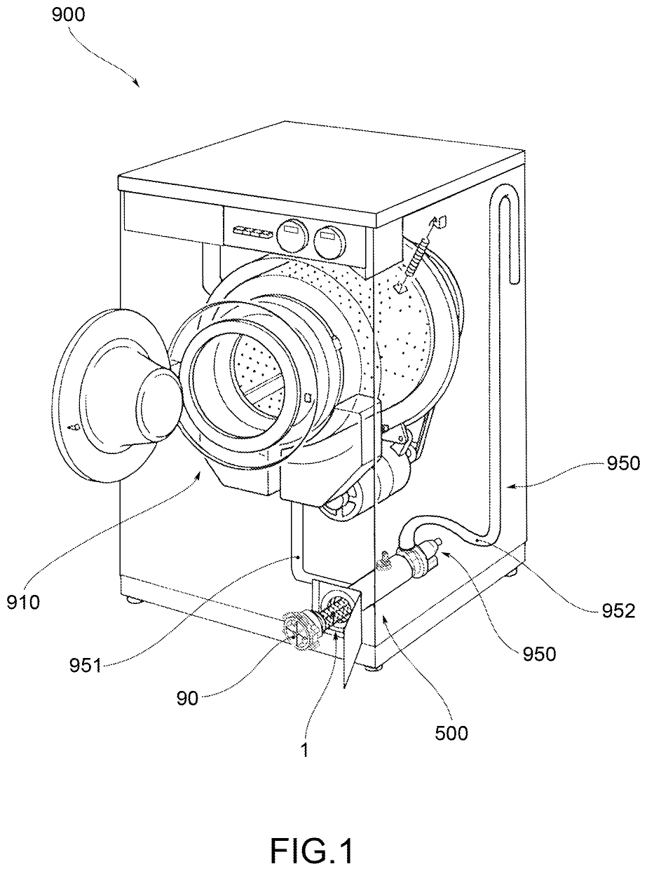

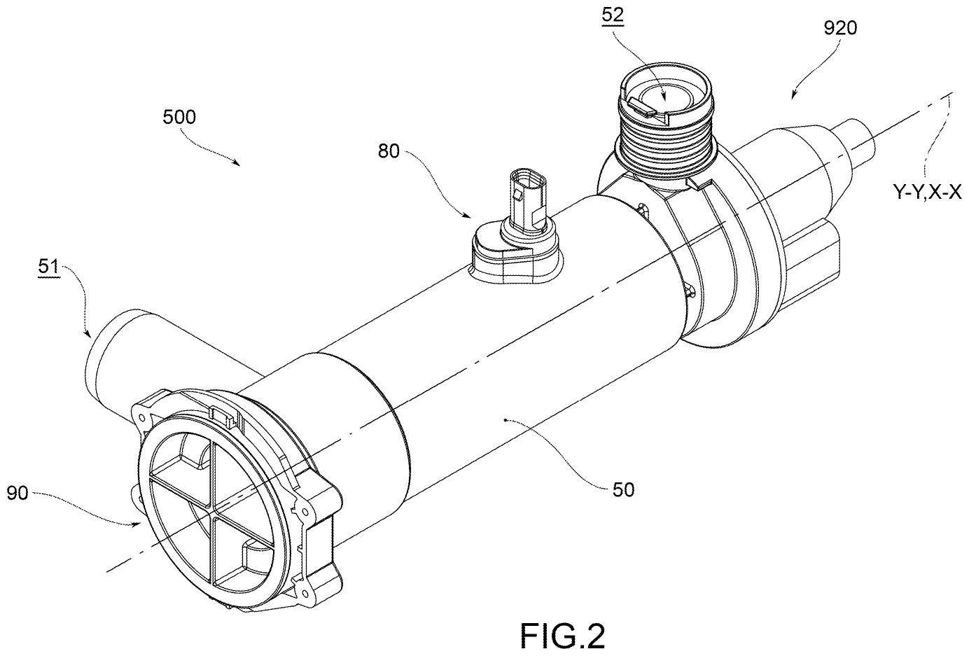

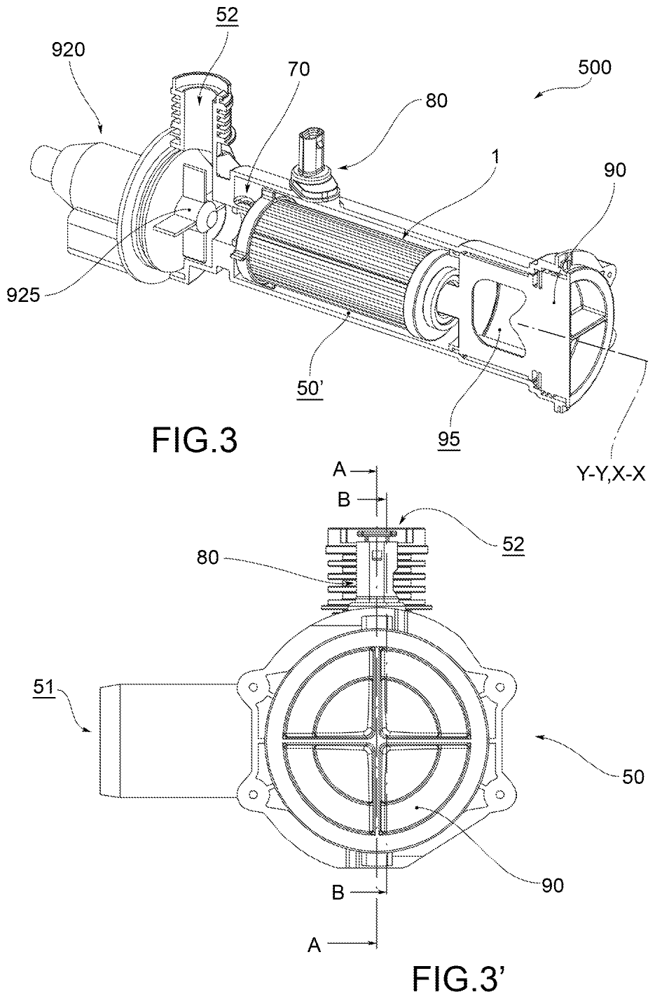

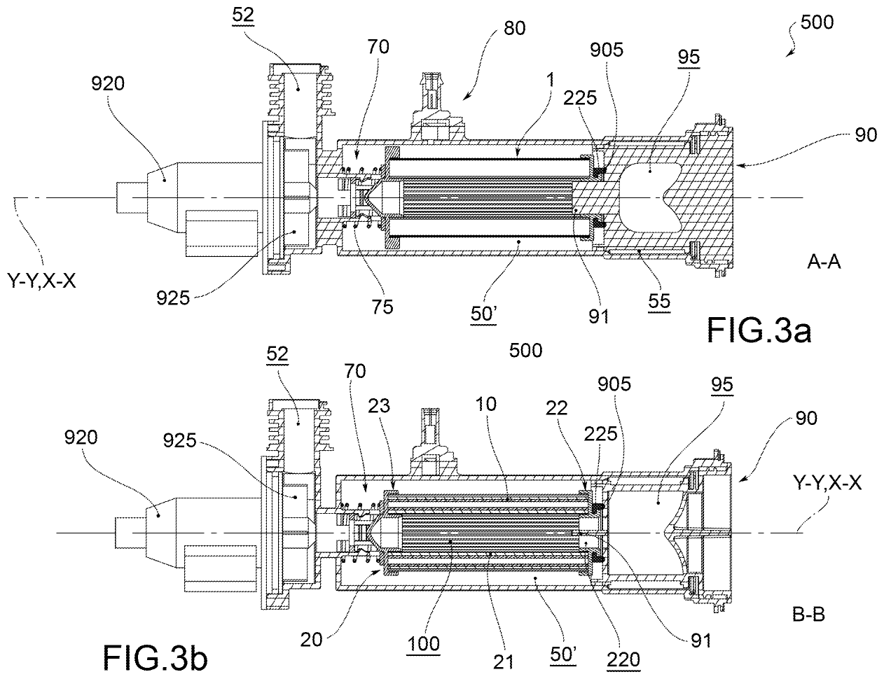

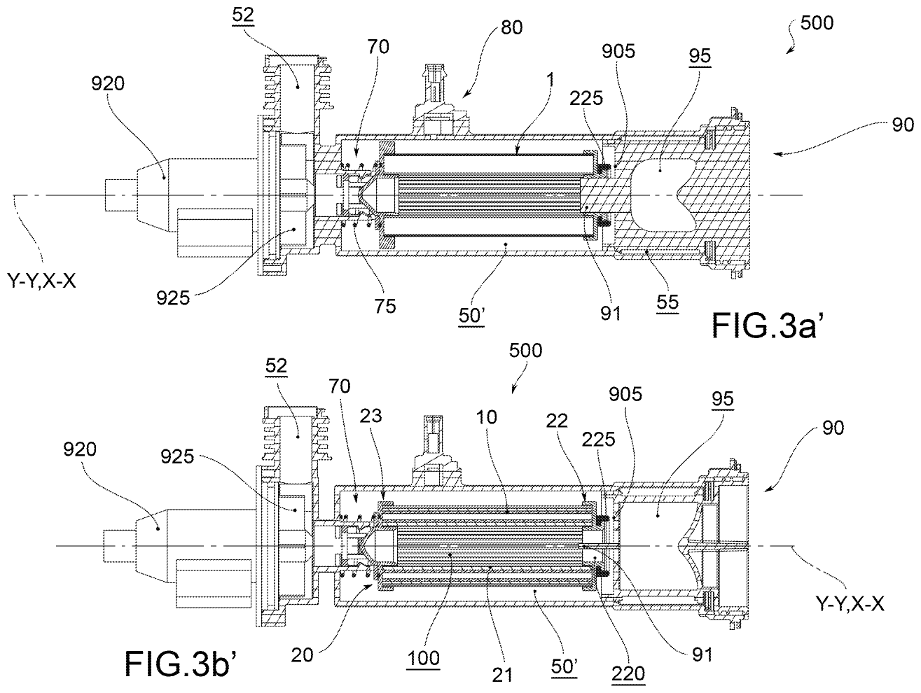

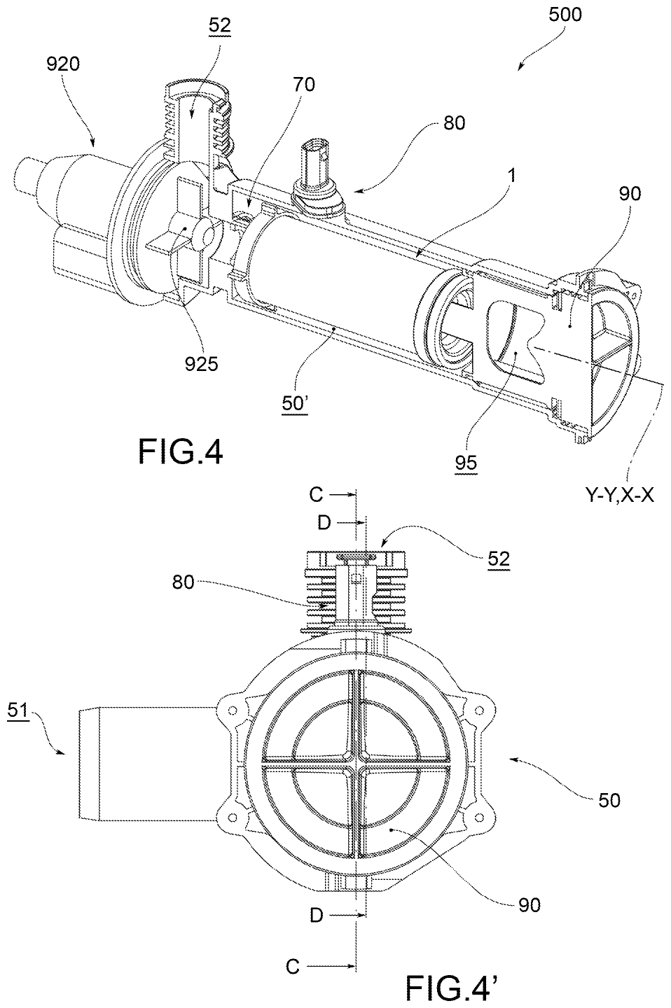

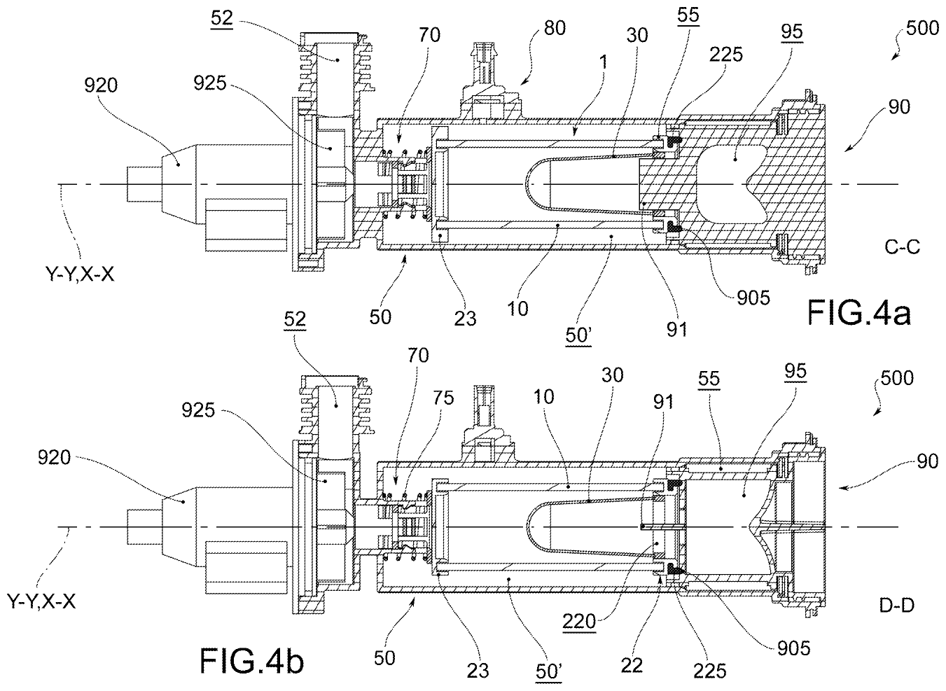

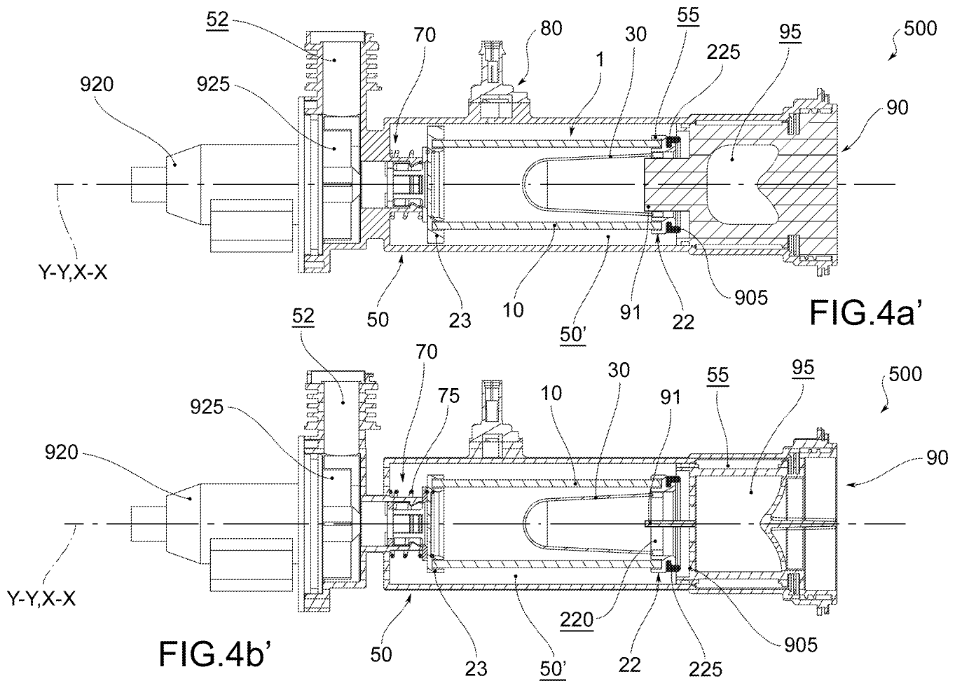

### DETAILED DESCRIPTION

With reference to the appended figures, reference number 900 denotes a washing machine according to the present invention. In addition, again with reference to the appended figures, reference number 1 denotes a filter group, which is in turn the subject of the present invention. Such filter group 1 is in effect comprised in said washing machine 900 or is suitable to be part of a washing machine according to the present invention as described hereinafter.

According to the present invention, the washing machine 900 comprises a drum in which washing operations are carried out. One should note that the present invention is not limited to the type, shape, size, positioning, orientation, i.e. rotation axis, operating mode (e.g., rotation speed and centrifuge) of the drum.

According to the present invention, the washing machine 900 comprises a drainage hose 950 fluidically connected to the drum 910 (or more generally to the drum housing) and fluidically connectable to a domestic or industrial drainage system for draining the water used in the drum 910.

According to a preferred embodiment, the washing machine 900 comprises a drainage pump group 920 positioned along the drainage hose 950 to drain water from the drum 910. According to a preferred embodiment, said drainage pump group 920 operates in suction with respect to the drum 910. Preferably, the drainage pump group 920 comprises an impeller 925 the rotation of which controls the suction action.

According to the present invention, the washing machine 900 also comprises a filter group 1 suitable for filtering synthetic microfibers of micrometric dimensions. In other words, the filter group 1 filters microfibers having a diameter greater than 1 micron and a length greater than 50 microns, preferably between 50 microns and 5 mm.

According to the present invention, the washing machine 900 also comprises a filter group 1 suitable for filtering synthetic microfibers of micrometric dimensions, i.e. having a diameter greater than 10 microns and a length greater than 50 microns, preferably between 50 microns and 5 mm.

In particular, in effect, the filter group 1 is positioned along said drainage hose 950. Said drainage hose 950 is thus divided by the presence of the filter group 1 into a first section 951 fluidically connected to the drum 910 and a second section 952 fluidically connectable to the drainage system. In the first section 951 “dirty” water flows, i.e. containing water, dissolved detergents, dirt and above all said synthetic microfibers, while in the second section 952 “filtered water” flows, i.e., cleaned of said synthetic microfibers.

According to the present invention, the filter group 1 comprises a tubular filter medium 10 extending along a filter axis X-X identifying a central cavity 100.

The filter medium 10 may be radially crossed by the flow of water.

According to a preferred embodiment, the filter medium 10 is radially crossed from the inside to the outside: in other words, the central cavity 100 defines the “dirty side” of the filter group 1, while the “clean side” is outside of it.

According to the present invention, the filter medium 10 is made of a non-woven fabric suitable for filtering synthetic microfibers of micrometric dimensions. Micrometric synthetic microfibers are understood to be fibers with a diameter greater than 1 micron, preferably microns, and a length greater than 50 microns, preferably between 50 microns and 5 mm.

In other words, the non-woven fabric has open winding passages through which the “dirty” water flows towards the side downstream of the filter medium while the synthetic microfibers are blocked by means of the windings defined by the mutual interweaving of the synthetic fibers that compose the non-woven fabric of the filter medium 10. In particulates, due to their relatively long length, the synthetic microfibers remain trapped on the entry surface of the non-woven fabric and/or in the windings of the non-woven fabric without being able to reach the outlet side of the filter and thereby reach the drainage system.

According to a preferred embodiment, the filter medium 10 is made from a sheet of filter material, preferably non-woven fabric, arranged in the shape of a star. Preferably, the star-shaped filter medium 10 has a high filtering surface, as well as a series of spaces which may be occupied by the microfibers (with respect to tubular or panel filters of the same dimensions).

According to a preferred embodiment, the filter medium 10 is a filter material, preferably non-woven fabric, made in a tube or cylinder shape. For example, the filter medium 10 is obtained from a sheet of filter material, preferably non-woven fabric, wound into a tube or cylinder shape. In accordance with this preferred embodiment, the filter medium 10 is a tube/cylinder made of non-woven synthetic fiber having a wall thickness greater than 0.3 mm, preferably between 0.8 mm and 3 mm.

According to a preferred embodiment, the non-woven fabric is made of synthetic PLA (polylactic acid) fibers. According to a preferred embodiment, the non-woven fabric is made of synthetic polypropylene and/or polyester and/or polyamide fibers or a combination thereof. Preferably, the non-woven fabric is made of single-component synthetic fibers. Preferably, the non-woven fabric is made of bicomponent synthetic fibers. According to a preferred embodiment, the non-woven fabric comprises a polyester core coated with polypropylene.

In accordance with the above, and as also seen below, due to the random structure of the non-woven fabric, the filter medium 10 is highly permeable to water without limiting the filtering effectiveness: in effect, the filtering structure is extremely efficient, i.e. with a very permeable fibrous structure (with low pressure drop) while at the same time being able to capture synthetic microfibers with a smaller diameter than the average diameter of the pores composing the filter material.

According to a preferred embodiment, the filter medium 10 and in particular the non-woven fabric sheet is produced by a spun-bond, air laid, spun-laid or melt blown methodology. Due to these processing technologies, the synthetic fibers that make up the filter medium 10 are joined/welded, preferably intertwined in a random manner, creating with each other a porous structure useful for the filtration of pollutant microfibers and at the same time able to minimize the release into the environment of the fibers of the filter medium 10. According to a preferred embodiment, the filter medium 10 and in particular the non-woven fabric sheet is produced spun-laid with bicomponent synthetic fibers with polyester core (PET or PBT) and polypropylene coating (PP). This combination makes it possible to give the synthetic fibers certain bulk mechanical characteristics (useful, for example, for the workability of the medium, in particular bendability) and specific surface properties useful for water filtration.

In accordance with a preferred embodiment, the filter medium 10 and in particular the tube/cylinder made of non-woven fabric is produced by means of melt-blown methodology with polyolefin-based synthetic fibers, polyester-based synthetic fibers, polyamide-based synthetic fibers, PLA-based synthetic fibers or a combination thereof.

In accordance with a preferred embodiment, the filter medium 10 and in particular the tube/cylinder made of non-woven fabric is produced by means of melt-blown technology with polyolefin-based synthetic fibers and/or with functionalized polyester-based synthetic fibers and/or modified with suitable additives (e.g. anion, cationic or apolar surfactants) to give the surface of the fibers (and thus of the filter group) hydrophilic properties capable of favoring the wettability of the filter medium towards water. This combination makes it possible to give the synthetic fibers certain bulk mechanical characteristics (useful, for example, for the workability of the medium, such as spinning using melt-blown technology) and specific surface properties useful for water filtration.

According to a preferred embodiment, the filter group 1 comprises a support structure 20 on which the filter medium 10 is mounted.

Preferably, the support structure 20 comprises two end plates 22, 23 arranged at the axial ends of the filter medium 10, e.g., a first end plate 22 and a second end plate 23. Preferably, the end plates 22, 23 are welded to the ends of the filter medium 10.

According to a preferred embodiment, the first end plate 22 is fluidically upstream of the second end plate 23. In other words, the first end plate 22 is intercepted by the dirty water before the second end plate 23.

Preferably, depending on the direction of flow, and the various components also described below, the first end plate 22 comprises a first through opening 220. Preferably the second end plate 23 is closed. Preferably, the second end plate 23, closed, axially delimits the central cavity 100 comprised in the filter medium 10. Preferably, the central cavity 100 is reached by the water to be filtered through the through opening 220.

According to a preferred embodiment, the first through opening 220 is made on the first end plate 22 at the filter axis X-X.

According to some embodiment variants, the support structure 20 comprises an inner structure 21 extending into the cavity 100 and connecting the two end plates 22, 23. According to some embodiment variants, not shown in the appended figures, the support structure 20 comprises an outer structure, i.e. on the outer side of the filter cartridge 1, connecting the two end plates 22, 23.

Preferably, the support structure 20 has a substantially mesh structure to allow the passage of the water flow in the radial direction.

According to a preferred embodiment, said support structure 20 is made of a plastic material, thus being recyclable.

According to a preferred embodiment, the filter group also comprises a safety pre-filter 30 fluidically positioned upstream of the filter medium 10.

Preferably, the object of the safety pre-filter 30 is therefore to perform a coarse filtration of any foreign bodies in the water during drainage, such as coins, staples, hair, tissues, socks, foliage, grass or parts thereof.

In particular, in effect, the safety pre-filter 30 filters elements larger than 1-2 mm2.

In other words, due to the safety pre-filter 30, these bodies are prevented from reaching the filter medium 10 and clogging it in a short period of time. In other words, clogging of the filter medium 10 and potential blocking by overloading the drainage pump group 920 is avoided.

According to a preferred embodiment, the safety pre-filter 30 is a mesh element, a permeable fabric, or an open mesh grid, having through passages of sizes ranging from 1-2 mm2 through which the water flows.

Preferably, in the configuration in which the filter medium 10 operates from the inside to the outside, the safety pre-filter 30 is housed in said central cavity 100.

According to a preferred embodiment, the safety pre-filter 30 extends along the filter axis X-X. Preferably, the safety pre-filter 30 has a tubular or substantially conical or substantially truncated-cone shape.

According to a preferred embodiment, the safety pre-filter 30 is comprised in the central structure 21.

According to a preferred embodiment, said safety pre-filter 30 is made of a plastic material, thus being recyclable.

According to a preferred embodiment, the entire filter group 1 is made of plastic material, thus being entirely recyclable.

According to a preferred embodiment, the filter medium 10 does not affect the operation of the drainage pump group 920. In particular, according to a preferred embodiment, the drainage pump group 920 is of the type comprising a standard type pump, equipped with an impeller 925 the rotation of which is electrically controlled, preferably, with a maximum flow rate of 1000 l/h, suction head between 80 and 120 mbar).

According to a preferred embodiment, the filter medium 10 does not involve a pressure drop that results in a stalling situation of the drainage pump group 920. In other words, the presence of the filter medium 10 does not entail the need to have a drainage pump group 920 with a greater power than a washing machine solution such as those of the known art in which there is no filter group in accordance with the above description.

According to a preferred embodiment, moreover, the filter medium 10 has a permeability value equal to or greater than 2000 l/(m2s) or more. Preferably, the filter medium 10 has a permeability value equal to or greater than 2900 l/(m2s). Preferably, the filter medium 10 has a permeability value equal to or greater than 2500 l/(m2s). Preferably the filter medium has permeability between 2900 l/(m2s) and 4000 l/(m2s). In particular, said permeability values are measured according to the standard EN ISO 9237:1995 on a sample with an area of 20 cm² at 200 Pascal.

According to a preferred embodiment, the washing machine 900 comprises a bypass group 70 operatively connected to the filter group 1 to control it in a filtration configuration in which the water flows from the first section 951 to the second section 952 through the filter medium 10 and a bypass configuration in which the water flows from the first section 951 to the second section 952 bypassing the filter medium 10.

According to a preferred embodiment, the filter group 1 is axially movable, and each configuration corresponds to a respective axial position.

In particular, said bypass group 70 operates between the aforesaid configurations according to the pressure acting on the dirty side of the filter medium 10. In other words, the bypass group 70 operates between the aforesaid configurations according to the amount of fibers accumulated in the filter medium 10: the greater the clogging of the filter medium 10, the greater the pressure acting on the dirty side

According to a preferred embodiment, the bypass group 70 comprises elastic means 75 suitable to perform an axial thrust action that keeps the bypass passage closed. If the action of the pressure on the dirty side is greater than the action of the axial thrust of the elastic means 75, the thrust force of the latter is overcome and thus the bypass passage is opened. In other words, if the pressure drop between the filter medium exceeds the action of the spring force, the bypass passage is opened.

According to a preferred embodiment in which the filter medium 10 is crossed from the inside to the outside and the water to be filtered enters the central chamber 100 through the through opening 220 finding the second end plate 23 closed (on which the bypass group operates), and the action of the pressure on the dirty side (i.e. in the central chamber 100) is greater than the action of the elastic means 75 and therefore the bypass passage is opened: in other words, the filter group 1 moves axially leaving a free passage near the first end plate 22 and therefore the passage of water through the filter medium 10 is not forced but bypassed.

According to a preferred embodiment, the washing machine 900 also comprises a pressure sensor group 80 suitable to detect the water pressure acting on the filter medium. In other words, the pressure sensor group 80 measures the pressure of the fluid circulating in the drainage hose and acts as an absolute pressure sensor.

According to a preferred embodiment, the pressure sensor group 80 detects the water pressure difference between the clean side and the dirty side of the filter medium 10.

In other words, the pressure sensor group 80 is suitable to detect the pressure drop due to the action of the filter medium 10.

According to a preferred embodiment, the washing machine 900 comprises a control unit that is operatively connected with said pressure sensor group 80, such that the latter is suitable to send a signal to said function control unit of that which it has detected. For example:
a normal operation signal, i.e. filter OK, with a measured pressure value (preferably pressure differential) lower than a first predetermined value;
a filter pre-clogging signal, i.e. filter low, with a measured pressure value (preferably pressure differential) greater than a first predetermined value and less than a second predetermined value;
an occluded filter and a bypass group active signal, i.e. filter full, with a measured pressure value (preferably pressure differential) greater than said second predetermined value;
an occluded filter and washing machine stop signal, i.e. filter to be replaced, with a pressure difference greater than said second predetermined value.

According to a preferred embodiment, the control unit is connected or corresponds to a control panel comprised in the washing machine 900. In this way the operator may be alerted to the maintenance status of the filter group 1 via the lighting up of one or more warning lights or via the display of the washing machine 900.

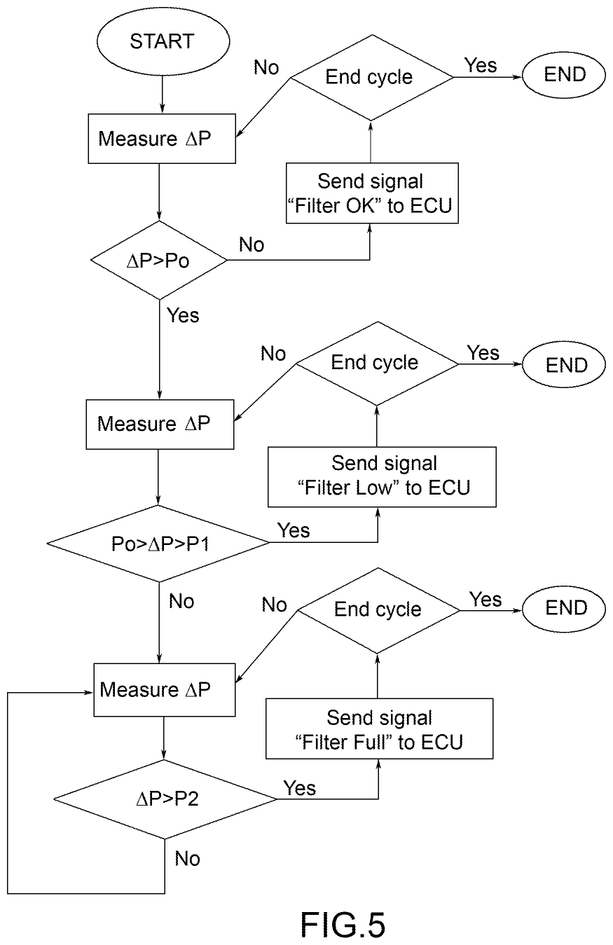

By way of example, FIG. 5 shows a schematic diagram of the operation of the washing machine 900 as a function of what is detected and signaled by the pressure sensor group 80.

According to a preferred embodiment, the washing machine 900 comprises a filter body 50 defining a filtration chamber 50′ in which the filter group 1 is housed.

Also said filter body 50 extends along a filter body axis Y-Y; in particular with the filter group 1 inserted, the filter body axis Y-Y corresponds to the filter axis X-X.

According to a preferred embodiment, the filter body 50 is positioned along the drainage hose 950, comprising an inlet mouth 51 fluidically connected with the first section 951 and an outlet mouth 52 fluidically connected with the second section 952. Preferably, the inlet mouth 51 communicates with the inner cavity 100 of the filter medium 10.

Preferably, the inlet mouth 51 and the outlet mouth 52 are in two opposite axial positions.

According to a preferred embodiment, the filter body 50 extends in length from an opening 55 made on an outer washing machine wall.

Preferably, the opening 55 is sealingly closable by a specially shaped cover group 90.

According to a preferred embodiment, the filter group 1 is insertable/removable as a cartridge through said opening 55.

According to a preferred embodiment, the cover group comprises a water connection 95 through which water flows suitable to fluidically connect the inlet mouth 51 and the filter group 1, preferably the inner cavity 100 of the filter medium 10.

According to a preferred embodiment, the filter group 1 is mountable, fixable to the cover group 90 such that it is fluidically connected thereto, and is insertable/removable as a cartridge in the maintenance and replacement operations of the filter group 1.

According to a preferred embodiment, the cover group 90 comprises special support and sliding ribs 91 on which the filter group 1 slides axially. Preferably, said support and sliding ribs 91 extend internally to the filter medium 10 in the central cavity 100 through the through opening 220 present on the first end plate 22.

According to a preferred embodiment, the cover group 90 and the filter group 1, and in particular the first end plate 22 are mutually engaged; in particular, in the filtration configuration the end plate 22 axially engages the cover group 90 to seal it. Preferably, the cover group 90 comprises a sealing seat 905 for hermetically sealing the bypass passage. Preferably, the first end plate 22 comprises a sealing element 225, e.g., an axial gasket acting along a direction parallel to the axis X-X, suitable for engaging said sealing seat 905.

According to a preferred embodiment, the bypass passage is controlled directly by the first end plate 22, and in particular by its axial position relative to the cover group 90. Preferably the sealing element 225 is axially tightened by the elastic means 75 acting on the second end plate 23.

According to a preferred embodiment, the bypass group 70 and/or the pressure sensor group 80 in accordance with the above may be housed or operate in the filter body 50.

According to a preferred embodiment, the drainage pump group 920 may be housed and operates in the filter body 50: for example, the impeller 925 of the drainage pump group 920 is housed inside the filter body 50, for example in the filtration chamber 50′ or in a specific adjacent impeller chamber (downstream thereof) and fluidically connected with the filtration chamber 50′.

The filter group 1 alone for a washing machine 900 with the characteristics described above and the advantages listed below is also the subject of the present invention.

A filtration system 500 of a washing machine 900 comprising the above described filter body 50 and the above described filter group 1, insertable/removable as a cartridge, is also the subject of the present invention.

Innovatively, the washing machine, the filter group and the filtration system of the present invention widely fulfil the object of the present invention by solving the problems that emerged in the typical solutions of the state of the art. Advantageously, in effect, synthetic microfibers produced in the washing of synthetic fabrics are retained and are therefore not discharged into the drainage systems and therefore into the environment.

Advantageously, the washing machine, the filter group and the filtration system of the present invention overcome the problem of environmental pollution of microplastics.

Advantageously, the filter group operates without affecting the operation of the other components of the washing machine such as the drum and especially the drainage pump group.

Advantageously, the filter group is installable in a compact space without requiring any substantial change in the architecture/layout of a washing machine.

Advantageously, the filter group is installable in a compact space easily identifiable even on the known washing machines available on the market. Advantageously, the filter group is installable as a retrofit in the current washing machines available on the market.

Advantageously, the use of the filter group of the present invention obviates the need to require changes in the architecture of the washing machine and to the technical characteristics of its main components such as, for example, the drainage pump group.

Advantageously, the filter group may be sized and has physical characteristics depending on the available dimensions of the washing machine on which it is installable, for example depending on whether the washing machine is domestic or industrial.

Advantageously, the filter group may be sized and has physical characteristics depending on the power of the drainage pump group, for example its maximum flow rate (variable depending on the type of washing machine) and its head (indicatively suitable to drain water from the drum up to the drainage outlet of the drainage system positioned at an indicative height of 1-2 m from the ground).

Advantageously, the filter medium is composed of a non-woven fabric that is easily permeable but at the same time capable of retaining micrometric fibers with considerable advantages to the pressure drop of the circuit. Advantageously, the filter medium in non-woven fabric has high permeability while being suitable to effectively filter water, i.e. it has an extremely effective behavior compared to any technical solutions wherein a mesh filter for filtering microfibers would have a very dense structure and therefore not very permeable.

Advantageously, the filter group results in a pressure drop less than or equal to 10 mbar.

Advantageously, the filter group operates effectively in filtration until it is saturated with synthetic microfibers. Advantageously, the filter medium intercepts and accumulates a certain amount of microfibers allowing the normal operation of the drain function (without overloading the drainage pump group). Advantageously, the end-of-life condition of the filter group is determined when the pressure drop imposed by the filter does not allow the drainage pump group to perform the drainage phase, i.e. with a pressure drop of 30-40 mbar or more.

Advantageously, the filter group is made of recyclable materials.

Advantageously, once the filter group is full, the bypass group intervenes, avoiding stoppage of the washing machine during an operating phase.

Advantageously, the status of the filter group is monitored while keeping the operation of the washing machine monitored.

Advantageously, the washing machine prevents the start of new washing cycles when the capacity of the filter group is exhausted, avoiding the deliberate emission of pollutant microfibers.

Advantageously, a safety pre-filter that filters larger components is also integrated into the dimensions of the filter medium.

Advantageously, the maintenance and replacement operations of the filter group are simple and intuitive.

Advantageously, the filter group is a simple component with low costs and allows the structure of the washing machine to be kept relatively simple.

Advantageously, the microfibers are accumulated on the inner side of the filter group avoiding the release of microfibers into the environment at the time of maintenance operations.

It is clear that a person skilled in the art may make modifications to the washing machine, filter group and filtration system so as to satisfy contingent requirements, all contained within the scope of protection as defined by the following claims.

### LIST OF REFERENCE NUMBERS

1 filter group
10 filter medium
20 support structure
21 internal structure
22 first end plate
220 first through opening
225 sealing element
23 second end plate
30 safety pre-filter
50 filter body
50′ filtration chamber
51 inlet mouth
52 outlet mouth
55 opening
70 bypass group
75 elastic means
80 pressure sensor
90 cover group
905 sealing seat
91 supporting and sliding ribs
95 water connection
500 filtration system
900 washing machine
910 drum
920 drainage pump group
925 impeller
950 drainage hose
951 first section
952 second section
X-X filter axis
Y-Y filter body axis

1. A washing machine comprising:
a drum in which washing operations are carried out;
a drainage hose fluidically connected to the drum and fluidically connected to a drainage system;
a filter group positioned along said drainage hose dividing the drainage hose into a first section fluidically connected to the drum and a second section fluidically connected to the drainage system, wherein the filter group filters synthetic microfibers of micrometric size comprising a tubular filter medium extending along a filter axis identifying a central cavity, wherein the filter medium is radially crossed by the flow of water, wherein the filter medium is made of a non-woven fabric.

2. The washing machine according to claim 1, wherein the filter medium is made of a non-woven fabric of synthetic fibers made of polypropylene and/or polyester and/or polyamide.

3. The washing machine according to claim 2, wherein the synthetic fibers of the non-woven fabric are bicomponents, comprising a polyester core coated with polypropylene.

4. The washing machine according to claim 1, wherein the filter medium filters synthetic microfibers of micrometric dimensions, having a diameter greater than 1 micron, and a length between 50 microns and 5 millimeters.

5. The washing machine according to claim 1, wherein the filter medium is obtained from a sheet of non-woven fabric arranged in a star-shape, or is a non-woven fabric made in a tube or cylinder shape.

6. The washing machine according to claim 1, wherein the filter group comprises a support structure on which the filter medium is mounted, wherein said support structure comprises two end plates at axial ends of the filter medium.

7. The washing machine according to claim 6, wherein the support structure is made of a plastic material.

8. The washing machine according to claim 1, wherein the filter group comprises a safety pre-filter fluidically positioned upstream of the filter medium, wherein said safety pre-filter filters elements larger than 1-2 mm².

9. The washing machine according to claim 8, wherein the safety pre-filter is a mesh element, a permeable fabric, or an open mesh grid, having through passages of sizes ranging from 1-2 mm² through which the water flows.

10. The washing machine according to claim 1, comprising a drainage pump group positioned along the drainage hose to draw water from the drum.

11. The washing machine according to claim 10, wherein the drainage pump group is positioned fluidically downstream of the filter group, wherein the filter medium has a permeability value equal to or greater than 2000 l/m²s.

12. The washing machine according to claim 1, wherein the filter group is axially movable, and the washing machine further comprises a bypass group operatively connected to the filter group to control the filter group in a filtration configuration in which the filter group is positioned such that water flows from the first section to the second section through the filter medium and a bypass configuration in which the filter group is positioned so that water flows from the first section to the second section bypassing the filter medium.

13. The washing machine according to claim 12, wherein the bypass group comprises an elastic element to perform an axial thrust action on the filter group.

14. The washing machine according to claim 1, further comprising a pressure sensor group configured to measure water flow pressure.

15. The washing machine according to claim 13, comprising a pressure sensor group configured to measure water flow pressure, and a control unit operatively connected with the pressure sensor group, wherein the pressure sensor group is configured to send a signal to the control unit as a function of pressure difference measured:
a normal operation signal with a measured pressure value lower than a first predetermined value;
a filter pre-clogging signal with a measured pressure value greater than a first predetermined value and less than a second predetermined value;
an occluded filter and a bypass group active signal with a measured pressure value greater than said second predetermined value.

16. The washing machine according to claim 1, comprising a filter body defining a filtration chamber in which the filter group is housed, wherein the filter body extends along a filter body axis which with the filter group inserted corresponds with the filter axis, wherein said filter body comprises an inlet mouth fluidically connected with the first section and an outlet mouth fluidically connected with the second section, wherein the inlet mouth and the outlet mouth are in two opposite axial positions, wherein said filter body extends in length starting from an opening made on an external washing machine wall, wherein said opening is sealingly closable by a cover group, wherein the filter group is insertable/extractable as a cartridge through said opening.

17. The washing machine according to claim 16, wherein said cover group comprises a water connection through which water flows configured to fluidically connect the inlet mouth and the filter group.

18. A filter group for a washing machine according to any claim 1.

19. A filtration system for a washing machine according to claim 16, comprising:
the filter body;
the filter group which is insertable/extractable as a cartridge through the opening of the filter body.

20. Filtration system according to claim 19, comprising:
a bypass group operatively connected to the filter group to control the filter group in a filtration configuration in which the filter group is positioned such that water flows from the first section to the second section through the filter medium and a bypass configuration in which the filter group is positioned so that water flows from the first section to the second section bypassing the filter medium, the bypass group being housed in the filter body to engage the filter group.

21. The washing machine according to claim 1, wherein the filter medium is radially crossed by the flow of water from inside to outside.

22. The washing machine according to claim 1, wherein the filter medium is made of a non-woven fabric consisting of synthetic fibers.

23. The washing machine according to claim 1, wherein the filter medium filters synthetic microfibers of micrometric dimensions, having a diameter greater than 10 microns, and a length between 50 microns and 5 millimeters.

24. The washing machine according to claim 1, wherein the filter group comprises a safety pre-filter fluidically positioned upstream of the filter medium, housed inside the central cavity, wherein said safety pre-filter filters elements larger than 1-2 mm².

25. The washing machine according to claim 10, wherein the drainage pump group is positioned fluidically downstream of the filter group, wherein the filter medium has a permeability value equal to or greater than 2500 l/(m²s).

26. The washing machine according to claim 10, wherein the drainage pump group is positioned fluidically downstream of the filter group, wherein the filter medium has a permeability value equal to or greater than 2900 l/(m²s).

27. The washing machine according to claim 10, wherein the drainage pump group is positioned fluidically downstream of the filter group, wherein the filter medium has a permeability value between 2900 l/(m²s) and 4000 l/(m²s).

28. The washing machine according to claim 1, further comprising a pressure sensor group to measure water pressure difference between a clean side of the filter medium and a dirty side of the filter medium.
